(19) United States
(12) Patent Application Publication
(10) Pub. No.: US 2026/0074794 A1
(43) Pub. Date: Mar. 12, 2026

(54) TIME TO FAIL AND EDGE IMPACT SEQUENCE PREDICTIONS FOR OPTICAL TRANSCEIVERS

(71) Applicant: HEWLETT PACKARD ENTERPRISE DEVELOPMENT LP, Spring, TX (US)

(72) Inventors: Venugopal Vembrakat Ranganath Prabhu, Bangalore (IN); David McMullen, Groton, NH (US); Nagaraj Davanakatti, Bangalore (IN); Chandan Kenchegowda, Bangalore (IN); Pavithra Halappa Jakallannavar, Bangalore (IN); Narasimhasastry Kasavajjhula, Bangalore (IN); Varsha Kulkarni, Bangalore (IN); Chuan Peng, Houston, TX (US)

(21) Appl. No.: 18/936,768

(22) Filed: Nov. 4, 2024

(30) Foreign Application Priority Data
Sep. 12, 2024 (IN) 202441069067

(51) Int. Cl. H04B 10/40; H04B 10/079

(52) U.S. Cl. CPC H04B 10/40; H04B 10/07955

(57) ABSTRACT

Systems and methods are provided for predicting a time until failure of an optical transceiver that is used within a context of a storage area network. In order to proactively take the optical transceiver offline or otherwise replace the transceiver before its failure affects the larger network, a long short-term memory recurrent neural network is executed to predict the time that remains until a predicted failure of the transceiver. The degradation in transmission power of the transceiver is monitored until a point at which the value falls below a threshold. This then causes the neural network to be executed and an alert message to be provided to a customer, informing them of the predicted time until failure of the particular component within their larger network.

### BACKGROUND

Optical communication technology is used in some computing networks to increase speed, cable length and overall bandwidth for communication between different networking devices (e.g., server device to a network router, among network switches). Storage networking is one such networking application, which employs optical communication technology (e.g., optical fiber cables, optical transceiver modules) within the industry.

Particularly, storage area networks (SANs) can employ optical fiber connections to achieve long range network communication. For example, when optical communication technologies and optical interfaces are employed, a SAN is capable of offering data rates up to 256 Gbps across metropolitan area distances (e.g., up to about 6 miles or 10 km). Furthermore, various optical components, including optical transceivers, are increasingly being integrated into networking devices. For instance, switches that are employed in storage networking may be equipped with optical transceivers in order to leverage the enhanced capabilities of optical communication technology to tackle the unique demands of storage networking, such as data growth, demanding workloads and high-performance.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of a network configuration that may be implemented for an organization, such as a business, educational institution, governmental entity, healthcare facility or other organization, in accordance with the disclosure.

FIG. 2 illustrates a portion of the network configuration that was introduced in FIG. 1, wherein computing devices of a service provider network are configured to send an alert to a customer when optical transceivers within the portion of the network shown are nearing a point of failure, in accordance with the disclosure.

FIG. 3 illustrates an architecture of the computing devices that are configured to predict a “time until failure” of the optical transceivers illustrated in FIG. 2, in accordance with the disclosure.

FIG. 4 illustrates a series of program instructions that, when executed, may be used to perform one or more portions of the methods described herein for predicting a time until failure of an optical transceiver, in accordance with the disclosure.

FIG. 5 further illustrates program instructions that, when executed, may be used to incorporate a machine learning model into the given computing platform, in accordance with the disclosure.

FIG. 6 further illustrates program instructions that, when executed, may be used to incorporate natural language processing into the given computing platform, in accordance with the disclosure.

FIG. 7 illustrates a computing platform that may be used to implement examples of the disclosed technology.

The figures are not exhaustive and do not limit the present disclosure to the precise form disclosed.

### DETAILED DESCRIPTION

A storage area network (SAN) is a dedicated high-speed network or subnetwork that interconnects and presents shared pools of storage devices to multiple servers. The availability and accessibility of storage devices are critical concerns for enterprise computing. Traditional direct-attached disk deployments within individual servers can be a simple and inexpensive option for many enterprise applications, but the disks, and the vital data those disks contain, are tied to the physical server across a dedicated interface, such as Serial Attached Small Computer System Interface (SAS). However, modern enterprise computing often demands a much higher level of organization, flexibility, and control, thereby driving the evolution of the SAN.

The amounts of data traffic that may be experienced by a storage network, such as a SAN, e.g., data centers in medium to large-scale enterprise infrastructures, can drive operating rates of optical transceivers that are utilized throughout the SAN. As will be described in greater detail below, an optical transceiver is a component that impacts overall efficiency and performance of a SAN, and it may be beneficial to mitigate, or at least predict, a failure of an optical transceiver in the storage network infrastructure.

Optical transceivers may be configured to provide health and status related information that may then be used to make such a prediction of a time until failure of a given optical transceiver. For example, near real-time transmission power values of the optical transceiver provide an indication of current operating capabilities with respect to either an intended operating range of the device, or with respect to values that the transceiver was previously operating at. By monitoring that trend, a prediction as to how much time the optical transceiver is predicted to remain operational can be made.

Accordingly, examples of the disclosed technology provide systems and methods for proactively detecting that a given optical transceiver is trending towards failure, is nearing end of life, or is otherwise at risk of otherwise disrupting network connectivity and degrading performance of a SAN. In particular, examples of the disclosed technology execute a long short-term memory (LSTM) recurrent neural network in order to make predictions regarding the health or state of an optical transceiver. The architecture of an LSTM recurrent neural network is particularly well suited for applications pertaining to time series data. As such, configuring an LSTM recurrent neural network to predict a time until failure of an optical transceiver, as opposed to some other algorithmic method for making such calculations, provides a more accurate and reliable estimate to customers. The disclosed “time to fail” prediction capabilities then permit the customer to have a window of time (e.g., days) before the device's failure for a corrective action (e.g., autonomous function, intervention of a network administration, replacement of the optical transceiver) to be performed to avoid a catastrophic failure of the network that would otherwise result from allowing the optical transceiver to reach the point of failure while it is still being utilized by the local networking device and the larger SAN.

A SAN can support a large number of storage devices, providing an increased amount of storage volume and greater storage accessibility in the infrastructure. Also, storage arrays (e.g., special designed storage subsystems) that support a SAN can scale to hold hundreds, or even thousands, of disks. Similarly, servers with a suitable SAN interface can access the SAN and its vast storage potential, and a SAN can support many servers. Further, a SAN can improve storage availability. Because a SAN is essentially a network fabric of interconnected computers and storage devices, a disruption in one network path can usually be overcome by enabling an alternative path through the SAN fabric. Thus, a single cable or device failure does not leave storage inaccessible to enterprise workloads. Also, the ability to treat storage as a collective resource can improve storage utilization by eliminating “forgotten” disks on underutilized servers. Instead, a SAN offers a central location for all storage, and enables administrators to pool and manage the storage devices together.

SANs can utilize Fibre Channel (FC) to implement the network's infrastructure, supporting connections and interfaces within the storage network. For example, a SAN can particularly employ the FC networking technology to connect multiple storage arrays, and server hosts, through FC switches to establish a regional network dedicated to data storage in the SAN. FC is a high-speed networking technology that can be used for transmitting data among data centers, computer servers, switches, and storage at data rates of up to 256 Gbps. FC was developed to overcome the limitations of previous large-scale networking technologies, such as Small Computer System Interface (SCSI) and High-Performance Parallel Interface (HIPPI), by providing a reliable and scalable high-throughput and low-latency protocol and interface. Consequently, FC is especially suited for connecting servers to shared storage devices and interconnecting storage controllers and drives, which is applicable within SAN architectures.

To further improve efficiency and throughput in networking, optics are increasingly being integrated within networking devices, such as routers, switches, and controllers. Particularly, networking devices that are employed within the SAN architecture, such as FC switches, can be integrated with optical components to further leverage the capabilities of optical networking technology. For example, an FC switch equipped with multiple optical transceivers enables optical communications between the servers and the storage device, in a manner that achieves high bandwidth and low-latency in the SAN. As background, an optical transmitter may electronically modulate a carrier light provided by a laser to convey information over an optical channel, converting electrical signals to optical signals on a transmit channel. An optical transmitter is normally accompanied by an optical receiver across an optical fiber. An optical receiver converts detected light signals to electrical signals. An optical transmitter and optical receiver together form an optical transceiver. Accordingly, as used herein, the term optical transceiver refers to a device (or module) that uses fiber optical technology to send and receive data, and thereby conveys information over an optical channel (e.g., transmit and receive optical signals).

The amounts of data traffic that may be experienced by a storage network, for example data centers in a medium to large-scale enterprise infrastructures, can drive the required operating rates of the optical transceivers that are utilized throughout the SAN. In other words, the optics of a FC switch, for example, should support high-speed links that are capable of moving the data through the SAN to keep up with an ever-increasing demands of data access and also maximize the performance (and reduce latency) of the storage resources. In the industry, the 10 G rate port in optical transceivers has been iterated to the 40 G rate, and the 40 G rate port has been upgraded to the 100 G rate port. With the cost reduction and maturity of single-channel 25 G optical modules, 25 G rate ports are also quite cost-effective options. As technology advances, data centers in the future will continue to undergo internal massive calculations with the rise of computation intensive system, such as artificial intelligence (AI), virtual reality (VR), and other applications. As a result, there may be a rapid increase of data transmission within SAN as these technological applications expand, and the 25 G, 32 G, 64 G, and even 100 G, optical transceiver market for these storage networking environments will continue to grow at a high speed. For example, an FC switch having 6 4G optical transceivers can support high-speed optical communications (over multi-mode optical fiber) at a rate that is suitable for the data growth, demanding workloads, and high performance that may be expected for a large-scale storage network infrastructure.

Given the scale, complexity, and unhindered speed at which a SAN may operate at, proactively repairing or otherwise mitigating the risk of even one failing component within the larger network enables the SAN to operate at a high capacity with consistency. As referred to herein, the “time to fail” can therefore be considered a a maintenance metric that indicates the amount of time that a part, component, or system can run before it experiences a failure that leads to severe malfunction or inoperability. In some cases, the predicted “time to fail” can be considered the remaining lifespan on the given optical transceiver and its components.

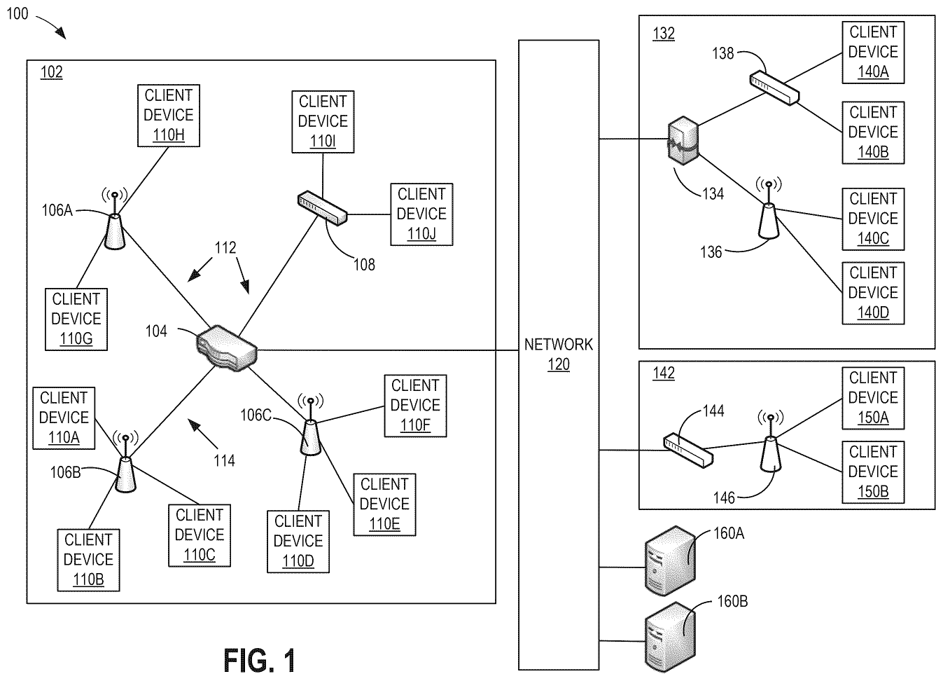

Before describing examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and multiple communication points with network 120. In some examples, the controller 104 may communicate with the network 120 through a router. In other examples, the controller 104 provides router functionality to the devices in the primary site 102. In this specification, the word “tunnel” refers to an encapsulated mode of transporting data between AP and controller.

The controller 104 may be operable to configure and manage network devices, such as at the primary site 102, and may also manage network devices at the remote sites 132, 142. The controller 104 may be operable to configure and manage switches, routers, access points, and client devices connected to a network. The controller 104 may itself be, or provide the functionality of, an Access Point (AP).

The controller 104 may be in communication with one or more switches 108 or wireless Access Points (APs) 106A-C. Switches 108 and wireless APs 106A-C provide network connectivity to various client devices 110A-J. Using a connection to a switch 108 or AP 106A-C, a client device 110A-J may access network resources, including other devices on the (primary site 102) network and the network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110I-J. Client devices 110I-J may connect to the switch 108 and through the switch 108, may be able to access other devices within the network configuration 100. The client devices 110I-J may also be able to access the network 120, through the switch 108. The client devices 110I-J may communicate with the switch 108 over a wired or wireless connection 112. In the illustrated example, the switch 108 communicates with the controller 104 over a wired or wireless connection 112.

Wireless APs 106A-C are included as another example of a point of access to the network established in primary site 102 for client devices 110A-H. Each of APs 106A-C may be a combination of hardware, software, or firmware that is configured to provide wireless network connectivity to wireless client devices 110A-H. In the example of FIG. 1, APs 106A-C can be managed and configured by the controller 104. APs 106A-C communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be a satellite office, another floor or suite in a building, for example. The remote site 132 may include a gateway device 134 for communicating with the network 120. A gateway device 134 may be a router, a digital-to-analog modem, a cable modem, a digital subscriber line (DSL) modem, or some other network device configured to communicate with the network 120. The remote site 132 may also include a switch 138 and AP 136 in communication with the gateway device 134 over either wired or wireless connections. The switch 138 and AP 136 provide connectivity to the network for various client devices 140A-D.

In various examples, the remote site 132 may be in direct communication with primary site 102, such that client devices 140A-D at the remote site 132 access the network resources at the primary site 102 as if these client devices 140A-D were located at the primary site 102. In such instances, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various examples, the network configuration 100 may include one or more smaller remote sites 142, comprising only a gateway device 144 for communicating with the network 120 and a wireless AP 146, by which various client devices 150A-B access the network 120. Such a remote site 142 may represent, for example, an individual employee's home or a temporary remote office. The remote site 142 may also be in communication with the primary site 102, such that the client devices 150A-B at the remote site 142 access network resources at the primary site 102 as if these client devices 150A-B were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160A-B. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and controllers, which are not directly part of the network configuration 100 but that facilitate communication between the various parts of the network configuration 100, and between the network configuration 100 and other network-connected entities. The network 120 may include various servers 160A-B. In an example, servers 160A-B may comprise content servers that include various providers of multimedia downloadable and streaming content, including audio, video, graphical, or text content, or any combination thereof. Examples of content servers 160A-B include web servers, streaming radio and video providers, and cable and satellite television providers. The client devices 110A-J, 140A-D, 150A-B may request and access the multimedia content provided by the content servers 160A-B.

As illustrated in the network configuration 100, client devices 110, 140, and 150 rely on respective switches 108, 138, and 144 as part of corresponding pathways through network 120. The failure or unmonitored degradation of even one of those switches may affect multiple client devices, as also illustrated in FIG. 1. Moreover, such client devices may each resemble an individual customer, an enterprise, or any other customer interface. As such, a failure of even one of the switches may significantly hinder or limit the ability of an enterprise to make use of network configuration 100. In order to avoid such a potentially largescale domino effect, predicting times until failures for the respective switches 108, 138, and 144 allows the network configuration 100 to maintain the intended level of operability for each of the customers, companies, etc. of the affected network.

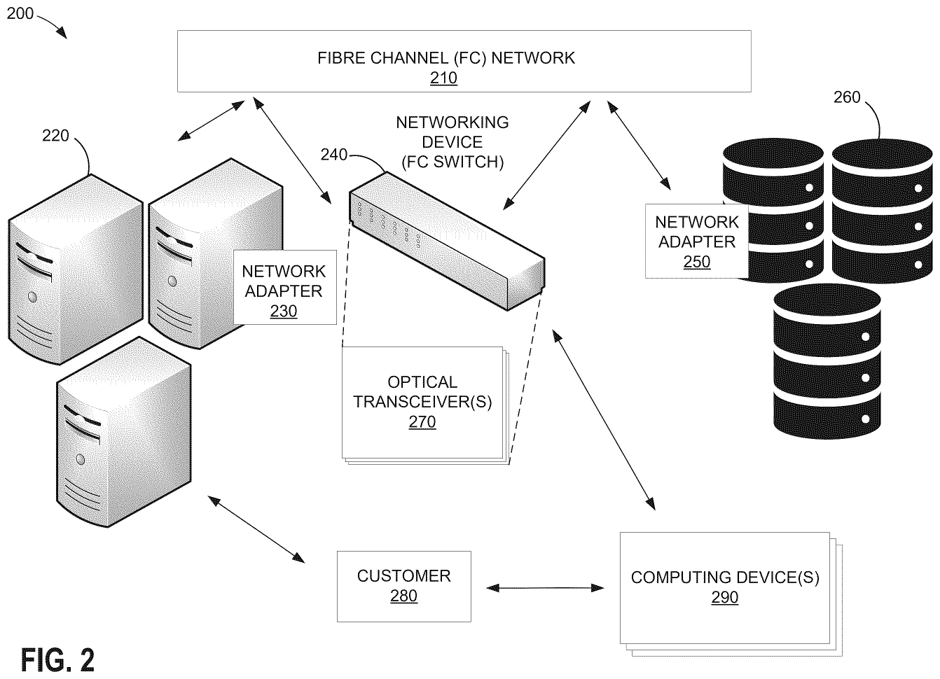

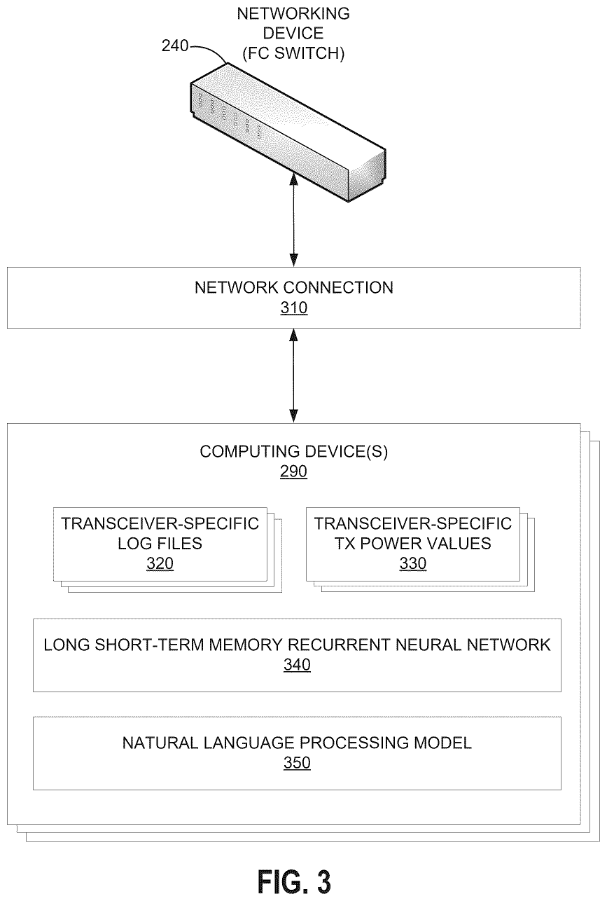

FIG. 2 illustrates a portion of the network configuration that was introduced in FIG. 1, wherein computing devices of a service provider network are configured to send an alert to a customer when optical transceivers within the portion of the network shown are nearing a point of failure. In addition, FIG. 3 illustrates an architecture of those computing devices that are configured to predict a “time until failure” of the optical transceivers illustrated in FIG. 2. The following section of the present disclosure discusses FIGS. 2 and 3 in conjunction with one another since there are overlapping components that are illustrated in both figures, such as networking device 240 and computing devices 290.

The example network configuration 200 is illustrated as a dedicated network that can be used for storage connectivity between multiple host servers 220 and shared storage devices 260 that deliver block-level data storage. Accordingly, the example network configuration 200 can be a SAN, or other known types of networks that can support interconnections to present shared pools of storage devices to hosts. Accordingly, the example network configuration 200 is shown to include a communication network 210 that supports high-speed data transfer technology, such as Fibre Channel (FC), that may be optimized for storage connectivity (e.g., access and distribution of stored data and storage devices) within a SAN. Thus, the communication network 210 is shown as an FC network. It should be noted that examples of the disclosed technology are not limited to such communication networks or protocols that use FC, but can also be used to provide connectivity in networks such as those that use telecommunication lines, such as phone lines, broadcast coaxial cables, satellite communications, cellular communications, etc.

Also illustrated in FIG. 2 is networking device 240 with an integrated optical transceiver 270. Although an optical transceiver will now be discussed within the context of examples shown in FIG. 2, it is a not intended to be limiting and the configuration and functions of networking device 240 disclosed herein can also operate within network configurations beyond storage networks and FC technology.

Additionally within the context of the example network configuration 200, is a customer 280 that may have designated access to servers 220. As customer 280 may desire frequent, reliable, and secure access to servers 220 and, by extension, storage devices 260, the customer 280 may benefit from receiving alert messages when one or more optical transceivers associated with the network configuration 200 may interfere with their usage of such a network (e.g., such as when a given optical transceiver is close to end of life or becoming unreliable or otherwise non-operational). As additionally explained above with respect to FIG. 1, it should be understood that customer 280 may resemble an individual customer of services provided via network configurations 100 or 200, may resemble an enterprise or company as a whole that has designated access to at least portions of servers 220, or may resemble a customer interface.

As an FC network, the communication network 210 implements high-speed data transfer that provides in-order, lossless delivery of data, such as the data within storage devices 260. Also, the communication network 210 provides the switch fabric that supports high-speed connections between the networked devices, namely the host servers 220, networking device 240, and the storage devices 260. The communication network 210 can operate in accordance with a standard for FC technology, including but not limited to: 16 G Fibre Channel; 32 G Fibre Channel (also referred to as “Gen 6” FC); 64 G Fibre Channel (also referred to as “Gen 7” FC); and 128 G Fibre Channel (referred to as “Gen 8” FC). As an example, the network configuration 200 is a SAN operating within a data center, where the communication network 210 supports the remote storage, processing, and distribution of large amounts of data between the host servers 220 and the storage devices 260. Furthermore, being consistent with FC technology, the communication network 210 enables data throughput speeds of up to 64 G within the storage networking architecture. As previously described, the communication network 210 can utilize optical fiber cables to implement the physical layer (or fabric layer) connections between the host servers 220, the networking device 240, and the storage devices 260. With optical-based connectivity, the communication network 210 leverages the speed, efficiency, and bandwidth benefits of optical technology for storage networking. Other forms of physical connectors (or cabling), such as copper cabling, can also be used by the communication network 210.

For instance, a deployment of the networking configuration 200 can be inside of data center, where the SAN implements increased I/O capacity to accommodate massive amounts of data, applications, and workloads, while providing low latency, increased server virtualization, and adoption of emerging storage technologies for high-speed data processing, such as Flash-based storage, and Non-Volatile Memory Express (NVMe). Moreover, the networking configuration 200 provides an increased reliability and resiliency of storage networking operations by enhancing the functionality of the optical transceiver 270. As further described herein, computing devices 290 are configured to poll and receive information from optical transceiver 270 in order to proactively predict that the optical transceiver is going to fail before it malfunctions and its failure escalates to a larger scale (e.g., affecting the operation of the networking device or optical link). Consequently, by employing the machine learning techniques described herein to provide accurate predictions to customers, the network can prevent failures in its optical connectivity that would ultimately degrade the performance of the storage network, such as experiencing outages and data unavailability.

FIG. 2 also illustrates that the network configuration 200 includes a networking device 240, namely a switch, configured to operate in accordance with optical-based and FC technologies. Thus, the networking device 240 is shown particularly as an FC switch, which is compatible for use with a SAN, such as the example SAN shown in FIGS. 1 and 2. It should be appreciated that the networking device 240 may be implemented as any one of a number of different networking equipment or devices that have the capability to provide network connectivity, such as routers, bridges, gateways, hubs, repeaters, network cards, and the like. Although FIG. 2 shows a single networking device 240, this is not intended to be limiting for the network configuration 200 and one or more additional networking devices 240 can be implemented within a storage network, such as the example SAN of FIG. 2. For instance, several FC switches can be combined to create large SAN fabrics that interconnect thousands of servers and storage ports (see also the network configuration illustrated in FIG. 1).

In operation, for instance as an FC switch, the networking device 240 routes communication or data, particularly between the host servers 220 and the storage devices 260 within the SAN. As illustrated in FIG. 2, the networking device 240 can act as an intermediary between the servers 220 and storage 260. In the example network configuration 200, a server 220 has a network adaptor 230 that interfaces to a physical link to the networking device 240, rather than being attached directly to the storage devices 260. Likewise, a storage device 260 has a network adaptor 250 to facilitate a physical link to connect to the networking device 240.

As an operational example, one of the servers 220 can request to access a particular storage device from the storage devices 260 to retrieve data stored thereon. The networking device 240, acting as FC switch, inspects a data packet header, in order to determine the computing device of origin, and the destination, in order to forward the packet to the intended system. Based on this packet inspection, the networking device 240 directs the request to the appropriate destination, which corresponds to one of the storage devices 260.

Furthermore, the networking device 240 can have optical components integrated therein, such as the disclosed optical transceiver(s) 270. As a general description, the optical transceiver of networking device 240 supports the insertion and removal of fiber optic connectors to the networking device. The optical transceiver also implements various functions, such as performing electrical-to-optical conversion, supporting optical connectivity using high speed serial links over multi-mode optical fiber at data rates ranging from 16 G/32 G NRZ up to 57.8 Gb/s PAM4 (the serial line rate of 64 G FC), for example, and link distances up to 10 km (and beyond). Target applications for such an optical transceiver 270 can include various forms of networking, such as LAN Ethernet and SAN Fibre Channel. In a given example, the optical transceiver 270 of networking device 240 is implemented as a short wave (SW) (e.g., optical wavelength approximately 850 nm) small form-factor pluggable (SFP) optical transceiver. The optical transceiver can be implemented as one of the emerging generations of SFP optical transceivers, such as SFP28 - SFP56, or other forms of SFP optical transceivers, such as Quad Small Form Pluggable (QSFP), Quad Small Form Pluggable Double Density (QSFP-DD), and the like. Accordingly, in the SW SFP56 FC configuration, the optical transceiver 270 is a compact and hot-pluggable device that acts as an interface between the networking device 240 and the interconnecting cabling, such as fiber optic cables. For example, the optical transceiver 270 can be physically inserted into an input port of the networking device 240. In turn, the fiber optic cable can be installed in the optical transceiver, thereby connecting the fiber optic cable to the networking device 240. In a given instance, the networking device 240 is an FC switch that includes multiple ports, where multiple optical transceivers can be installed to support parallel traffic streams and enable greater bandwidth than can be achieved through a single FC connection.

Furthermore, networking device 240 may comprise many electrical and optical components that enable the functionalities described above. For example, networking device 240 includes an optical transmitter and optical receiver. The optical components can include several components that perform the optical transceiver's optical-based capabilities, such as generating or detecting optical signals. Moreover, the optical transmitter and optical receiver are included in a portion of networking device 240, namely the optical transceiver 270, that houses the components that enable data transmission and reception over fiber optic cable. For example, the optical transceiver 270 can include a transmitter optical subassembly (TOSA) at the transmit side, which includes a laser diode and an optical interface bus. The receiver side of the optical transceiver 270 can comprise a receiver optical sub-assembly (ROSA), which includes a photodiode, a trans-impedance amplifier (TIA), and an electrical interface. The networking device 240 may also include additional components that enable its functions, such as a read-only memory (ROM) or other memory element (used to store information such as clock data in the electrical input signal), an IC chip, a multiplexer/demultiplexer (MUX/DEMUX), drivers, etc.

As illustrated in FIGS. 2 and 3, computing devices 290 are configured to receive communications from networking device 240 via network connection 310 and to send communications to customer 280. For example, computing devices 290 request certain health parameters pertaining to optical transceiver 270 from networking device 240 in order to monitor general status and operability of the optical transceiver. Examples of such health parameters include transmission power of the optical transceiver 270 and log files of networking device 240 or of optical transceiver 270 specifically.

In response to computing devices 290 periodically polling for an updated transmission power value of optical transceiver 270, networking device 240 is then configured to send the updated transmission power value via network connection 310. Computing devices 290 then store the transmission power values in storage 330. Storage 330 may refer to any local storage space within computing device 290 or any remote storage that computing devices 290 have access to, such as a database.

In addition, computing devices 290 may also periodically poll for updated log files of optical transceiver 270, which may also be sent via networking device 240 and similarly stored in storage 320. The log files, as additionally described below, may be applied via natural language processing for determining an expected impact to the SAN if optical transceiver 270 were indeed to fail and become non-operational.

As illustrated in FIG. 3, storages 320 and 330 are specific to each optical transceiver, meaning that computing devices 290 tracks such progress reports and status updates for each optical transceiver individually. Monitoring each optical transceiver individually thus ensures that computing devices 290 can deduce which optical component of the given networking device 240 has begun to fail.

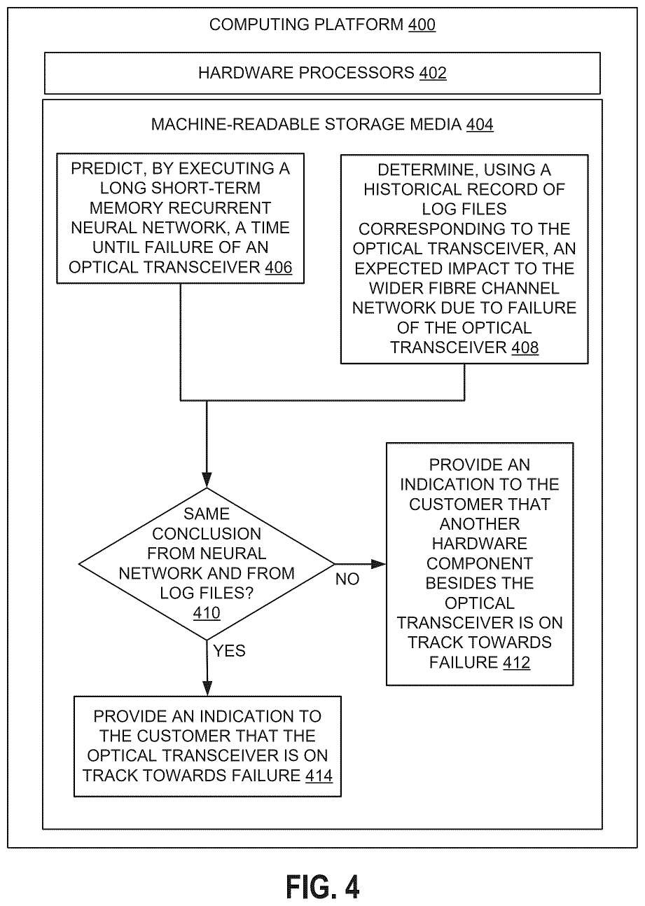

Furthermore, and as additionally described below with regard to FIG. 4-7, upon receiving an updated transmission power value, computing devices 290 may be configured to determine whether or not the value is at or below a fixed threshold before. If the value is still above the threshold, then the corresponding optical transceiver is determined to be fully operational, and the value is not stored. If the value is below the threshold, then the corresponding optical transceiver is determined to be only partially operational and is considered to be degrading such that a “time until failure” should therefore be calculated.

The calculation of a “time until failure” of the optical transceiver 270 predicts an amount of time in the future where the optical transceiver 270 could reach the defined “fail” value, and such a proactive prediction, while optical transceiver 270 is at that moment in time still at least partially operational, avoids such a catastrophic failure of the transceiver. The amount of time that is predicted or forecasted by a long short-term memory (LSTM) recurrent neural network 340 is considered to be the “time to fail” for the optical transceiver 270. For example, the “time to fail” indicates a time (e.g., hours, days, total number of “power on” days) until the transmitter of the optical transceiver 270 will generate an optical signal power in a range that is so low that the component is considered to be malfunctioning or non-operational.

When determining a “time until failure,” the LSTM recurrent neural network 340 that is made accessible to computing devices 290 is executed in order to determine a predicted rate of degradation of optical transceiver 270.

Methods of determining such health-related data about optical transceiver 270 is additionally explained with regard to FIG. 4 - 7 herein.

If computing devices 290 indeed detect that optical transceiver 270 has fallen below an accepted operational threshold of transmission power, then the computing devices prepare and send an indication to customer 280 that the optical transceiver 270 has begun to degrade. The indication may also include an expected number of hours, days, etc. that the optical transceiver should still be expected to be operational before customer 280 should plan to replace the optical transceiver or otherwise address the issue in order to avoid larger scale impacts to network configuration 200.

Moreover, natural language processing model 350 may additionally be executed in order to detect patterns within event sequences that have been detailed in log files 320. Computing devices 290 may then be able to determine an expected impact if the particular optical transceiver 270 were to fail, and provide such information to customer 280. For example, if a failure of optical transceiver 270 were to cause information to be otherwise rerouted across the network configuration 100 or 200, then providing such information to customer 280 before such an occurrence allows them to take action to prevent these issues to the network.

Addressing again the LSTM recurrent neural network 340 which is executed in order to determine a time until failure of optical transceiver 270, this type of machine learning model is particularly well suited for making predictions based on time series data. The particular model illustrated by LSTM recurrent neural network 340 has been trained using labeled datasets in which previous monitoring of transmission power values and corresponding timestamps have been recorded until failure of various other optical transceivers. By utilizing the long short-term memory cells of this particular type of sequential or recurrent neural network, sequential inputs are propagated across the cells, thus optimizing this type of machine learning model for this particular type of time series analysis.

In some instances, LSTM recurrent neural network 340 may be constructed using the following parameters: a ‘relu’ activation layer, a mean squared error (MSE) loss function, and an ‘adam’ optimizer. Such a configuration of LSTM recurrent neural network 340 may enable a ≥92% prediction accuracy for determining times until failures of optical transceivers.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Determining that transmission power of an optical transceiver has dropped below a set threshold operability value detects that the signal strength of the transmitter is critically low, and may also indicate that the transmitter, or the optical transceiver 270 module as a whole, has degraded in a manner that may impact its proper function. In a scenario where the optical transceiver's 270 transmitter is simply allowed to fail, and the transceiver 270 cannot properly transmit data while the module is still installed and being employed by the networking device 240, there may be a loss of connectivity in the SAN which further leads to data unavailability. As previously described, reliability and accessibility are key metrics for the performance of storage networks, such as the SAN in FIGS. 1 and 2. Failure of an optical component, at a larger scale where the storage network handles massive amounts of data, applications, and workloads can gravely impede speed, create bottlenecks, and lead to further inefficiencies.

To prevent these aforementioned drawbacks that could be caused by a failure of the optical transceiver 270, computing devices 290 can perform calculations to predict the “time to fail” using the health parameters that are provided by networking device 240. As introduced above, the computing devices 290 begin storing the transmission power values only when a latest received value falls below the defined threshold operability value, in an effort to consume less memory/storage resources of the database that is made accessible to computing devices 290. A prediction of time until failure of the optical transceiver is then made by executing an LSTM recurrent neural network, and the result is then provided to the customer associated with a network connection that relies on the given optical transceiver.

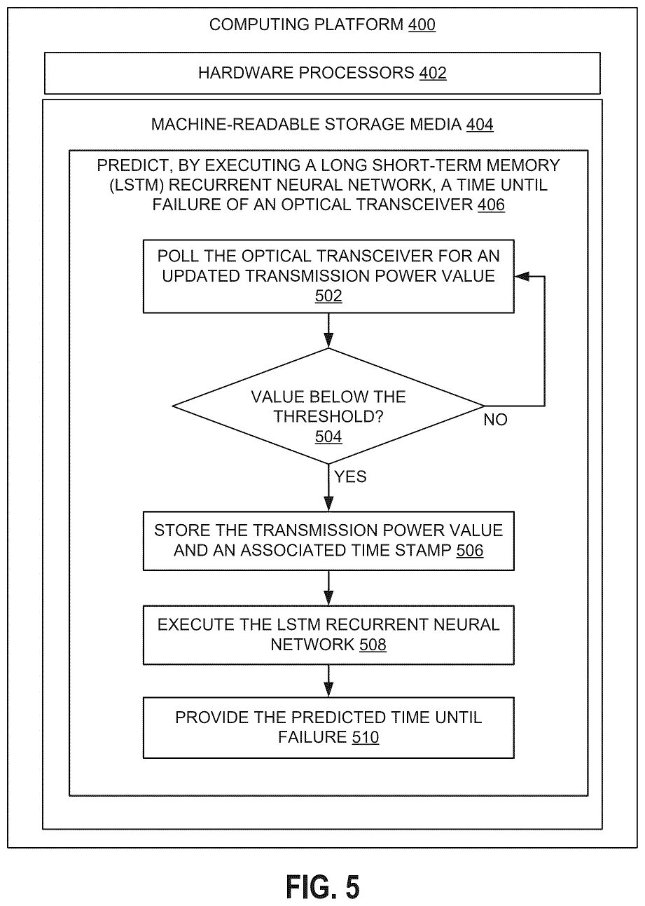

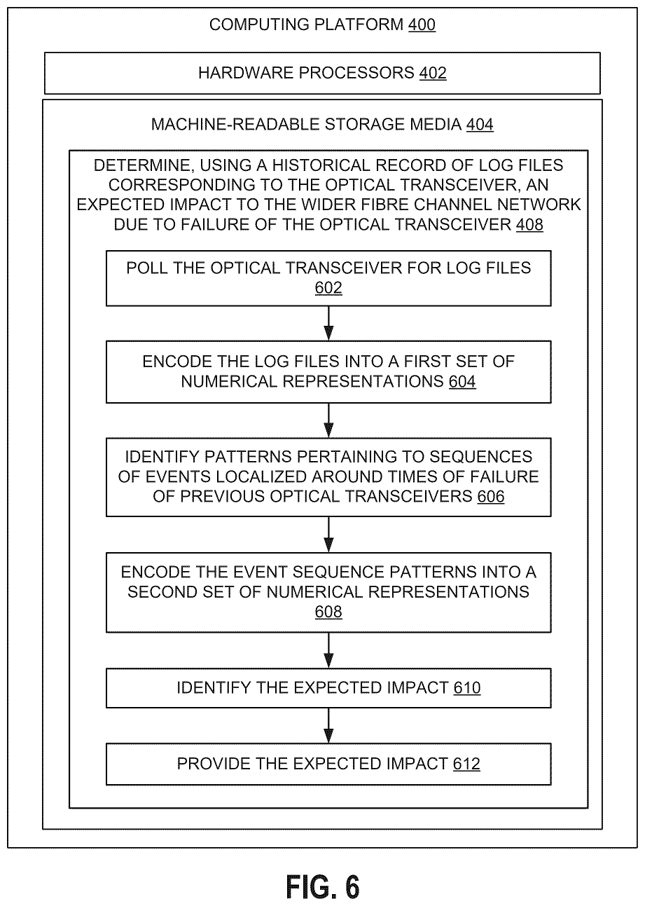

FIG. 4 illustrates a series of program instructions that, when executed, may be used to perform one or more portions of the methods described herein for predicting a time until failure of an optical transceiver. FIG. 5 then further illustrates program instructions that, when executed, may be used to incorporate a machine learning model into the given computing platform. FIG. 6 then further illustrates program instructions that, when executed, may be used to incorporate natural language processing into the given computing platform. The following section of the present disclosure may refer to FIGS. 4, 5, and 6 in conjunction with one another since FIG. 5 and FIG. 6 illustrate detailed process flow diagrams of the more general blocks 406 and 408, which are respectively shown in FIG. 4.

Referring now to FIG. 4, computing platform 400 may be, for example, a server computer, a controller, or any other similar computing component capable of processing data. In the example implementation of FIG. 4, the computing platform 400 includes a hardware processor 402, and machine-readable storage medium 404.

Hardware processor 402 may be one or more central processing units (CPUs), semiconductor-based microprocessors, or other hardware devices suitable for retrieval and execution of instructions stored in machine-readable storage medium 404. Hardware processor 402 may fetch, decode, and execute instructions, such as instructions 406-414, 502-510, and 602-612, to determine a time until failure prediction for various optical transceivers of the network. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-414.

In some instances, computing platform 400 may resemble any computing resource that is configured to operate one or more machine learning models, such as an LSTM recurrent neural network. As denoted by the use of the word “platform,” computing platform 400 may, for example, resemble a cloud-based service provider network that enables both rapid communication with customers of the service provider network and computing power with capabilities of efficiently running largescale algorithms such as the aforementioned LSTM recurrent neural network.

Hardware processor 402 may execute instructions 406-414, 502-510, and 602-612 in order to monitor near real-time operation of the various optical transceivers within the network configurations illustrated in FIGS. 1, 2, and 3, and proactively alert customers when optical transceivers are trending towards failure. Moreover, it should be understood that FIG. 4 depicts the passage of time as well, since computing platform 400 is configured to regularly poll the various optical transceivers in order to receive periodic updates about parameters such as transmission power values and log files.

In block 406, an LSTM recurrent neural network is executed in order to predict a time until failure of an optical transceiver. As additionally described with respect to FIG. 5 below, computing platform 400 may be configured to determine that a recently received transmission power value, pertaining to a given optical transceiver, has fallen below an acceptable threshold operability value. In order to predict the time remaining before the optical transceiver fails or otherwise becomes inoperable, the recently received transmission power value and a corresponding timestamp is provided as inputs to the LSTM recurrent neural network, which then outputs a predicted time until failure.

Furthermore, instructions illustrated in block 406 to execute the LSTM recurrent neural network may occur in parallel with the instructions illustrated in block 408. As additionally described with respect to FIG. 6 below, computing platform 400 may be configured to determine an expected impact to the wider SAN if the given optical transceiver were to fail or become non-operational.

Block 408 illustrates that, in addition to alerting the customer that an optical transceiver is trending towards failure, computing platform 400 is also configured to determine, using historical records of log files, the expected impact to the wider network due to failure of that particular optical transceiver. Such information may benefit the customer when they decide how quickly to act or how to act in order to prevent such impacts to performance of the SAN. Moreover, block 408 also resembles a cross-check that occurs within instructions 406-414. For example, if the given optical transceiver is indeed trending towards failure, then computing platform 400 may be configured to search the log files associated with that optical transceiver for “low transmission power” type alert messages.

Thus, results of blocks 406 and 408 may then be used to reconfirm that both the transmission power values and the recently captured log files positively indicate that the optical transceiver is indeed the component that is trending towards failure. This block 410 is a method for ensuring that no false positives would wrongly indicate to the customer that the optical transceiver is the component that is failing. For example, if “low TX power” alert messages were registered in the recent log files but the transmission power value of the optical transceiver had not yet fallen below the threshold operability value, then a different type of alert message may be prepared to send to the customer. For example, the alert message may indicate that some type of component that is local to the optical transceiver, such as a cable, is on track towards failure, but it does not appear to be the optical transceiver. This type of alert message is shown in block 412.

If, instead, both the information within blocks 510 and 612 indicate that the optical transceiver is indeed on track towards failure, then the alert message shown in block 414 will be provided to the customer. For example, the LSTM recurrent neural network predicts that the optical transceiver will remain operational for another 8 hours and similar “low TX power” messages have been received in the log files. The corresponding alert message to the customer will then indicate that 8 hours remain until the optical transceiver is predicted to become non-operational. The indication sent to the customer may prompt replacement of the optical transceiver prior to the predicted time until failure, as the LSTM recurrent neural network is configured to predict the beginning of the degradation of the optical transceiver that still provides a window of time to the customer that is on the order of hours or days in advance of the optical transceiver becoming completely non-operational.

At a later moment in time, computing platform 400 may be further configured to receive a confirmation that the given optical transceiver has been replaced, thus ensuring operability of the portion of the network affected by the previously degrading optical transceiver.

FIG. 5 further illustrates the multiple processing steps that may collectively be described by block 406 in FIG. 4.

As shown in block 502, computing platform 400 is configured to periodically poll the optical transceiver for a reading of the transceiver's current transmission power value. For example, computing devices 290 may communicate via network connection 310 in order to request and subsequently receive transmission power values from networking device 240. In some instances, computing platform 400 may be configured to poll the networking device for these values. However, in other instances, networking device 240 may be preconfigured to periodically send these values out across network connection 310 without a request from the computing devices.

As also introduced above, various implementations of optical transceivers, such as a small form-factor pluggable (SFP), will also impact the expected operational power range of said devices. For example, a given SFP may be configured to operate within a reception power range of 250 μW to 630 μW and within a transmission power range of 250 μW to 1000 μW. In another example, a different SFP may be configured to operate within a reception power range of 300 μW to 1000 μW and within a transmission power range of 300 μW to 790 μW. In yet another example, another SFP may be configured to operate within a reception power range of 340 μW to 1580 μW and within a transmission power range of 340 μW to 1580 μW.

Such variations in reception and transmission power ranges determine a threshold operability value that is used by computing devices 290 in order to determine whether or not the given optical transceiver is operational or trending towards failure. For example, if the absolute lower limit of transmission power for a given SFP is 250 μW in order for the SFP to be considered as operational, as in the first example above, then the threshold operability value may be set at some amount N μW above that absolute lower limit, such as 400 μW, in order to first detect that the optical transceiver is operating at less than full capacity but also has not yet become completely non-operational. The threshold operability values can therefore be defined as numerical values, quantities, limits/boundaries, and measurable factors that are related to the transmission power ranges.

The manner in which the threshold operability values are defined can be a critical design point with respect to the operation of the disclosure, and ultimately the “time to fail” prediction capabilities of the computing devices 290. For instance, threshold operability values defined with strict boundaries that are relatively close to the absolute lower limit of the transmission power range may cause there to be a higher confirmation of cause to believe that the optical transceiver is about to fail, but may leave less time for action to be taken. On the contrary, if the threshold operability value is defined with a strict boundary that is less close to the absolute lower limit of the transmission power range, this may allow for the customer 280 to have more time to react before the failure of the optical transceiver has a wider impact on the network configuration 100 or 200.

Returning to the depictions in FIG. 5, block 504 illustrates that computing platform 400 then determines whether or not the most recently received transmission power value is below a given threshold. The threshold resembles a point at which computing platform 400 is configured to deduce that the given optical transceiver is trending towards failure. Thus, the threshold operability value reflects some percentage lost with respect to the transmission power values received by the optical transceiver on day zero of operation, or some other baseline or factory setting value that provides an indication that performance of the optical transceiver has decreased.

If the updated transmission power value is still above the threshold operability value, then computing platform 400 is configured to continue regularly polling for new transmission power values and take no further action (e.g., the transmission power value is not stored). No further action is taken since the optical transceiver is still, at such a moment in time, to be considered as operational or not trending towards a near-term failure.

If the updated transmission power value is at or below the threshold operability value, then computing platform 400 is configured to store the current transmission power value along with a timestamp at which that particular value was received to computing platform 400. The timestamp serves as a first indication that the optical transceiver is now trending towards a near-term failure. In some instances, and as introduced above, the threshold depicted in block 504 may be fixed at 400 μW or some value that is quantitatively higher than the absolute lower limit of transmission power for the given device, and thus the first transmission power value that is stored, as indicated by block 506, is the first time that computing platform 400 receives a transmission power value that is at or below 400 μW.

It should also be understood that two process flows may exist from this moment in time forward: (1) computing platform 400 will continue to poll networking device 240 for updated transmission power values and will continue to store both the newly received values and their corresponding time stamps and (2) the LSTM recurrent neural network will be executed in order to provide a predicted time until failure to the customer.

With regard to the first process flow, computing platform 400 will continue to receive transmission power values and continue to store them in order to monitor the degradation of the optical transceiver. For example, if computing platform 400 polls networking device 240 each hour, then it may receive the first transmission power value that is at the threshold at 9:00 AM. Thus, computing platform will store the value, 400 μW, and the time stamp of 9:00 AM. Computing platform 400 may then continue to poll for updated transmission power values, and continue to record that the optical transceiver is operating at a transmission power value of 400 μW at 10:00 AM, at 11:00 AM, and at 12:00 PM, etc. Continuing with the example, computing platform may receive an indication that the optical transceiver is now operating at a transmission power of 350 μW at 1:00 PM, then again at 2:00 PM, and so forth. Such types of additional datapoints may also be provided to the LSTM recurrent neural network. In addition, the inputs to the LSTM recurrent neural network may instead be formulated as a duration of time at which the optical transceiver was operating at a given transmission power value. For example, the duration of time that the optical transceiver was operating at 400 μW was 4 hours.

The following paragraphs further detail blocks 506, 508, and 510 of FIG. 5 which illustrate the generation of the prediction of the time until failure of the optical transceiver.

In block 508, computing platform 400 is further configured to cause the LSTM recurrent neural network to be executed, due to the determination that the optical transceiver has begun to fall below the threshold for accepted level of operation. Furthermore, and as introduced above, the LSTM recurrent neural network receives the most recent transmission power value and corresponding timestamp as inputs. As the LSTM recurrent neural network resembles a trained neural network that has already been given and trained on labeled datasets, said neural network is configured to output a predicted time until failure of the optical transceiver, based on the new inputs provided.

In block 510, the predicted time until failure is provided. For example, the instruction in block 510 may resemble the providing of the value (e.g., estimated number of hours, days, etc. until failure) to the computing resource of computing platform 400 that is configured to perform the cross-check instructions in block 410.

FIG. 6 further illustrates the multiple processing steps that may collectively be described by block 408 in FIG. 4.

In block 602, computing platform 400 is configured to poll networking device 240 for log files that pertain to the given optical transceiver that is trending towards failure. In some instances, computing platform 400 may regularly request log files and store them independent of whether or not that particular optical transceiver has been detected as starting to fail. In other instances, computing platform 400 begins requesting log files after a moment in time in which the transmission power value of the optical transceiver has fallen below the threshold described in block 504.

In block 604, the text of the log files is encoded into a first set of numerical representations. In blocks 606 and 608, computing platform 400 is also configured to search through previous log files in order to determine similar sequences of events pertaining to degradation of optical transceivers. For example, certain key words, such as “port fencing,” “frame time out,” or “low TX power” alert messages may be determined to be relevant to the current context of the given optical transceiver within the local and wider SAN configuration. Those characters, words, or phrases are then encoded into a second set of numerical representations.

In block 610, a cosine similarity function is executed in order to rank and compare the first and second sets of numerical representations. For example, it may be determined that there seems to be a common theme within the logged sequence of events in which, if a “low TX power” alert message has been entered into the log file, then a “frame time out” message will follow, etc. Such similarities are used to provide customer 280 with relevant information pertaining to an expected impact if the optical transceiver were to continue to be allowed to degrade towards becoming non-operational.

In block 612, the quantifiable expected impact is then provided. For example, the instruction in block 612 may resemble the providing of expected impact to the computing resource of computing platform 400 that is configured to perform the cross-check instructions in block 410.

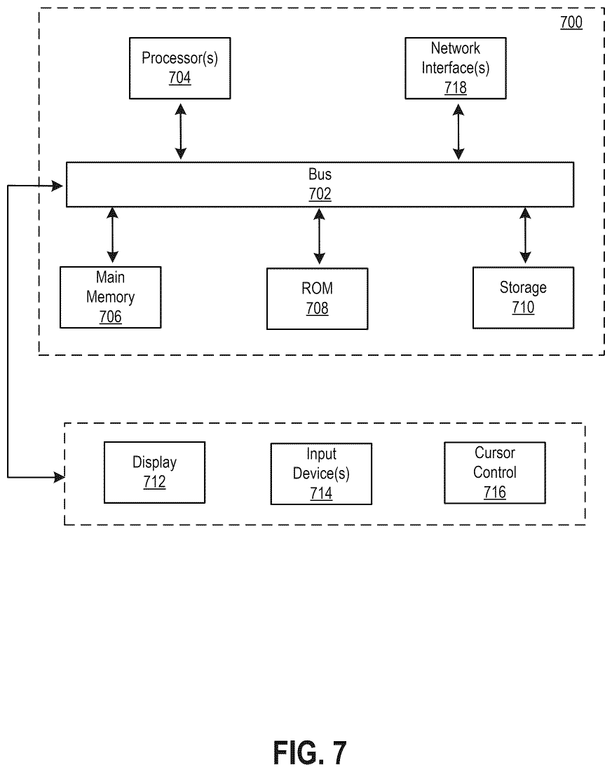

FIG. 7 depicts a block diagram of an example computer system 700 in which various examples of the disclosed technology described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, or may be comprised of programmable units, such as programmable gate arrays or processors.

The computer system 700 may implement the techniques described herein using customized hard-wired logic, one or more ASICs or FPGAs, firmware or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data or instructions that cause a machine to operate in a specific fashion. Such non-transitory media may comprise non-volatile media and volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
predicting a time until failure of an optical transceiver within a Fibre Channel (FC) network, wherein the predicting comprises:
polling the optical transceiver for transmission power values;
determining that a given one of the transmission power values is below a threshold operability value;
storing the given transmission power value and an associated time stamp; and
executing a neural network based, at least in part, on the given transmission power value and the associated time stamp, wherein the neural network outputs a predicted time until failure of the optical transceiver; and
providing an indication to a customer of the FC network of the predicted time until failure of the optical transceiver, the provided indication prompting replacement of the optical transceiver prior to the predicted time until failure.

2. The method of claim 1, further comprising:
determining an expected impact to the FC network given a failure of the optical transceiver, wherein the determination comprises:
polling the optical transceiver for log files;
encoding the log files into a first set of numerical representations;
identifying, based on a historical record of other log files, patterns pertaining to sequences of events localized around times of failure of other optical transceivers;
encoding the event sequence patterns into a second set of numerical representations; and
identifying, via the first and second sets of numerical representations, the expected impact; and
additionally providing the determined expected impact within the indication to the customer.

3. The method of claim 2, wherein the events within the event sequence patterns comprise one or more of:
a first alert that transmission power of a given optical transceiver of the other optical transceivers is below the threshold operability value;
a second alert that the given optical transceiver recorded a frame timeout; or
a third alert that a port that the given optical transceiver is connected to has been turned off.

4. The method of claim 2, wherein the identifying the expected impact comprises calculating a cosine similarity between the first and second sets of numerical representations and ranking results of the calculation.

5. The method of claim 2, further comprising determining, via a comparison between one or more events in the log files and the predicted time until failure, that the optical transceiver, and not another hardware component that is local to the optical transceiver, is on track towards failure.

6. The method of claim 2, further comprising:
determining, via a comparison between one or more events in the log files and the predicted time until failure, that another hardware component that is local to the optical transceiver, and not the optical transceiver, is on track towards failure; and
reformulating the indication that is to be provided to the customer to indicate that the other hardware component that is local to the optical transceiver is on track towards failure.

7. The method of claim 1, wherein the neural network is a long short-term memory (LSTM) recurrent neural network.

8. The method of claim 1, wherein the predicting the time until failure further comprises:
responsive to determining that the given one of the transmission power values is below the threshold operability value, continuing to poll for and store additional transmission power values and associated time stamps; and
causing the neural network to be re-executed based, at least in part, on the additional transmission power values and the associated time stamps, wherein the neural network outputs an updated predicted time until failure of the optical transceiver.

9. A method comprising:
predicting, via execution of a long short-term memory (LSTM) recurrent neural network, a time until failure of an optical transceiver within a Fibre Channel (FC) network;
determining, via a historical record of log files corresponding to the optical transceiver, an expected impact to the FC network given the failure of the optical transceiver;
providing an indication to a customer of the FC network of the predicted time until failure of the optical transceiver and the determined expected impact; and
receiving confirmation that the optical transceiver has been replaced.

10. The method of claim 9, wherein the predicting the time until failure of the optical transceiver comprises:
polling the optical transceiver for transmission power values;
storing received transmission power values; and
executing a neural network based, at least in part, on the transmission power values, wherein the neural network outputs a predicted time until failure of the optical transceiver.

11. The method of claim 10, further comprising:
responsive to determining that a first of the transmission power values is above a threshold operability value, continuing to poll the optical transceiver for additional transmission power values;
responsive to determining that a first of the additional transmission power values is below the threshold operability value, storing the first of the additional transmission power values and an associated time stamp; and
causing the neural network to be executed.

12. The method of claim 10, further comprising:
generating a training dataset for the LSTM recurrent neural network based on the stored transmission power values and their associated time stamps; and
retraining the LSTM recurrent neural network using the generated training dataset.

13. The method of claim 9, wherein the determining the expected impact to the FC network comprises:
determining an expected impact to the FC network given a failure of the optical transceiver, wherein the determination comprises:
polling the optical transceiver for log files;
encoding the log files into a first set of numerical representations;
identifying, based on a historical record of other log files, patterns pertaining to sequences of events localized around times of failure of other optical transceivers;
encoding the event sequence patterns into a second set of numerical representations; and
identifying, via the first and second sets of numerical representations, the expected impact; and
additionally providing the determined expected impact within the indication to the customer.

14. The method of claim 13, wherein the events within the event sequence patterns comprise one or more of:
a first alert that transmission power of a given optical transceiver of the other optical transceivers is below a threshold operability value;
a second alert that the given optical transceiver recorded a frame timeout; or
a third alert that a port that the given optical transceiver is connected to has been turned off.

15. A system, comprising:
an optical transceiver within a Fibre Channel (FC) network, configured to periodically send transmission power values and log files;
one or more processors; and
memory having program instructions that, when executed by the one or more processors, cause the one or more processors to:
predict a time until failure of the optical transceiver by receiving the transmission power values and executing a neural network based, at least in part, on the transmission power values, wherein the neural network outputs a predicted time until failure of the optical transceiver;
determine an expected impact to the FC network given a failure of the optical transceiver by receiving the log files and identifying, via natural language processing, patterns of event sequences within the log files;
provide an indication to a customer of the FC network of the predicted time until failure of the optical transceiver and the expected impact given the failure of the optical transceiver; and
receive confirmation that the optical transceiver has been replaced.

16. The system of claim 15, wherein to determine the expected impact, the program instructions further cause the one or more processors to:
encode the log files into a first set of numerical representations;
identify, based on a historical record of other log files, patterns pertaining to sequences of events localized around times of failure of other optical transceivers;
encode the event sequence patterns into a second set of numerical representations; and
identify, via the first and second sets of numerical representations, the expected impact.

17. The system of claim 15, wherein the program instructions further cause the one or more processors to:
determine, via a comparison between one or more events in the log files and the predicted time until failure, that the optical transceiver, and not another hardware component that is local to the optical transceiver, is on track towards failure.

18. The system of claim 15, wherein the program instructions further cause the one or more processors to:
determine, via a comparison between one or more events in the log files and the predicted time until failure, that another hardware component that is local to the optical transceiver, and not the optical transceiver, is on track towards failure; and
reformulate the indication that is to be provided to the customer to indicate that the other hardware component that is local to the optical transceiver is on track towards failure.

19. The system of claim 15, wherein the optical transceiver comprises a transmitter optical subassembly (TOSA) and a receiver optical subassembly (ROSA).

20. The system of claim 15, wherein the neural network is a long short-term memory (LSTM) recurrent neural network.
